(19) United States
(12) Patent Application Publication
(10) Pub. No.: US 2026/0229254 A1
(43) Pub. Date: Aug. 6, 2026

(54) GLASS SUBSTRATES FOR HEAT ASSISTED MAGNETIC RECORDING (HAMR) AND METHODS AND APPARATUS FOR USE WITH THE GLASS SUBSTRATES

(71) Applicant: Western Digital Technologies, Inc., San Jose, CA (US)

(72) Inventor: Shoji Suzuki, San Jose, CA (US)

(21) Appl. No.: 19/042,982

(22) Filed: Jan. 31, 2025

(51) Int. Cl. G11B 5/73; G11B 5/012; G11B 5/84

(52) U.S. Cl. CPC G11B 5/73921; G11B 5/012; G11B 5/84

(57) ABSTRACT

Aspects relate to a glass substrate. In some examples, the thickness of the glass substrate is less than 0.5 millimeters, and an activation energy for viscous flow of the glass substrate is greater than 250 kilojoules per mole. In some examples, the diameter of the glass substrate is greater than 95 millimeters. In some examples, a magnetic storage device includes a plurality of magnetic recording disks incorporating such a glass substrate. Aspects also relate to determining whether a glass substrate is suitable for use in a magnetic recording medium. In some examples, this determination is based on an activation energy of the glass substrate.

### FIELD

The present disclosure relates to magnetic recording media, and more particularly to magnetic recording media for use with heat assisted magnetic recording (HAMR) wherein the magnetic recording media have glass substrates, and further relates to methods and apparatus for use with such substrates.

### INTRODUCTION

Magnetic storage devices such as hard drive disks (HDDs) are storage devices that store data or information magnetically. Heat assisted magnetic recording (HAMR) techniques can potentially increase the areal density of information recorded magnetically, while avoiding data erasure caused by thermal fluctuations, by using high-coercivity media materials. The media materials may be deposited at high temperatures upon a glass-based disk substrate along with various other layers or materials. The high deposition temperatures can cause the disk substrate to expand and deform during the deposition of the various layers or materials. Conventionally, the expansion of a glass substrate used for HAMR is relatively small during the deposition process due to the low coefficient of thermal expansion of such a glass substrate.

### SUMMARY

A glass substrate for a magnetic recording medium is provided. The glass substrate has a thickness of less than 0.5 millimeters in some examples. An activation energy for viscous flow of the glass substrate is greater than 250 kilojoules per mole in some examples.

A magnetic storage device is provided. The magnetic storage device includes a plurality of magnetic recording disks, at least one magnetic head, a drive mechanism for positioning the at least one magnetic head over one or more of the plurality of magnetic recording disks, and a controller electrically coupled to the at least one magnetic head for controlling operation of the at least one magnetic head. Each of the plurality of magnetic recording disks includes a corresponding glass substrate. Each corresponding glass substrate has a thickness of less than 0.5 millimeters in some examples. An activation energy for viscous flow of each corresponding glass substrate is greater than 250 kilojoules per mole in some examples.

A method for determining a suitability of a glass substrate for use in a magnetic recording medium is provided. The method includes: determining an activation energy associated with a particular thickness of the glass substrate, the particular thickness being less than a thickness threshold; determining whether the activation energy is greater than an activation energy threshold; and determining whether the glass substrate is suitable for use in the magnetic recording medium based on the determining whether the activation energy is greater than the activation energy threshold.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations it should be understood that such implementations can be implemented in various devices, systems, and methods.

### BRIEF DESCRIPTION OF THE DRAWINGS

A more particular description is included below with reference to specific embodiments illustrated in the appended drawings. Understanding that these drawings depict only certain examples of the disclosure and are not therefore to be considered to be limiting of its scope, the disclosure is described and explained with additional specificity and detail through the use of the accompanying drawings, in which:

FIG. 1 is a plan diagram schematically illustrating a data storage device including a slider and a magnetic recording medium in accordance with one or more aspects of the disclosure.

FIG. 2 is a side schematic (profile) view of the slider and magnetic recording medium of FIG. 1 in accordance with one or more aspects of the disclosure.

FIG. 3 is side cross-sectional view of a magnetic recording structure with a glass substrate.

FIG. 4 is a flatness versus temperature graph that illustrates that flatness degradation of a glass substrate is higher at higher sputter deposition temperatures.

FIG. 5 illustrates an example of flatness degradation of a glass substrate after a sputter deposition process.

FIG. 6 is a flatness versus glass substrate thickness graph that illustrates that flatness degradation may be higher with thinner glass substrates.

FIG. 7 is a flatness versus temperature graph that illustrates that flatness degradation may be different for different glass substrates.

FIG. 8 is a flow diagram of an example method for determining whether a glass substrate is a suitable candidate in accordance with one or more aspects of the disclosure.

FIG. 9 is a flow diagram of another example method for determining whether a glass substrate is a suitable candidate in accordance with one or more aspects of the disclosure.

FIG. 10 illustrates a mapping of activation energy to temperatures associated with strain points and temperatures associated with annealing points in accordance with one or more aspects of the disclosure.

FIG. 11 is a flow diagram of an example method for determining an activation energy of a glass substrate in accordance with one or more aspects of the disclosure.

FIG. 12 is a flow diagram of another example method for determining an activation energy of a glass substrate in accordance with one or more aspects of the disclosure.

FIG. 13 is side cross-sectional view of a magnetic recording structure with a glass substrate characterized in accordance with one or more aspects of the disclosure.

FIG. 14 illustrates an example apparatus configured to determine whether a glass substrate is a suitable candidate (e.g., for a heat assisted magnetic recording (HAMR) process) in accordance with one or more aspects of the disclosure.

### DETAILED DESCRIPTION

In the following detailed description, reference is made to the accompanying drawings, which form a part thereof. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

The glass transition temperature (Tg) parameter has been used to select glass material for use in HAMR media. This selection method has been found to be acceptable if the substrate thickness is greater than 0.5 millimeters (mm) and/or the deposition temperature is lower than Tg by a few hundred degrees. Demands for higher HDD capacity require thinner disks and higher deposition temperatures. However, the selection of a glass material based on Tg is not sufficiently rigorous for these higher capacity applications.

The disclosure relates in some aspects to a glass substrate that has properties sufficient for use for certain magnetic recoding media (e.g., heat assisted magnetic recording (HAMR) media). For example, the flatness degradation of such a glass substrate may be acceptable at the high deposition temperatures associated with HAMR media. In some examples, the thickness of the glass substrate is less than 0.5 millimeters, and an activation energy for viscous flow of the glass substrate is greater than 250 kilojoules per mole.

The disclosure also relates in some aspects to various methods, apparatuses, systems, methods, and media associated with such a glass substrate. For example, such a method may involve determining whether a glass substrate is suitable for use in a magnetic recording medium. In some examples, this determination is based on an activation energy of the glass substrate. In some examples, this determination is based on sputter conditions such as sputter temperature, sputter duration, and glass thickness.

### HAMR

For purposes of illustration, various aspects of the disclosure will be described in the context of a memory system that incorporates HAMR memory technology. HAMR is a magnetic storage technology for use in storage devices such as hard disk drives wherein storage material is temporarily heated during the writing of data, potentially allowing for significant increases in areal density of data as compared to other magnetic storage technologies, such as traditional perpendicular magnetic recording (PMR), helium-filled drives or shingled magnetic recording (SMR). The magnetic storage disk used for HAMR (a single disk is discussed here, though hard disk drives often have multiple such disks) may have a glass substrate upon which various magnetic recording layers and other layers are deposited. If the deposition temperature, which may depend on the substrate glass material, approaches a glass transition temperature, the viscosity of the glass may decrease exponentially (i.e., the glass softens). This softening can lead to deformation of bulk material as flatness deviations or “creep.” For example, the substrate may deform to a concave or convex shape resulting in a disk that is not flat. Such a deviation from the preferred flat surface can cause variations to magnetic signals applied to (or obtained from) the disk, especially to a servo track signal. This can reduce the track density capability and consequently lower capacity. In addition, the outer diameter (OD) edges of such deformed disks are closer to a load/unload ramp in the hard disk drive and can also reduce the shock performance.

Accordingly, it is desirable in at least some examples that a top surface of the substrate be sufficiently flat so the layers deposited thereon can be well-suited to reliable high density data storage. Note that flatness is not necessarily a localized geometrical feature of a disk. The entire disk may have a concave, convex, saddle, or cylindrical shape. Such macroscopic variations can give an undesirable flying trajectory to a magnetic head/slider, especially after clamping. A clearance between the OD edge of a disk and the load/unload ramp may also be compromised and thus reduce the tolerance to the shock events, where the OD edge moves due to the vibration and hits the ramp material. If this happens during device operation, the disk edge can generate wear debris and such can trigger a head crash and/or signal erasures.

An additional adverse effect of a degradation in the flatness of a disk relates to clearance variations between the disk and the head-suspension and load/unload ramp components of the hard disk drive. Both loading and unloading radial positions are determined by the clearance between the disk surface and the load/unload ramp. The radial position, how close the head moves toward the outside diameter (OD) edge, is an important factor in disk design. If a disk has a convex shape, the top surface of the disk is further away from the load/unload ramp component and the opposite side of the disk is closer to the ramp. Moreover, clearance variations may result in differences in the loading timing versus the unloading timing. This, in turn, may result in the head being retracted too early or too late.

In some aspects, a flatness metric can be determined for the substrate that quantifies the aforementioned flatness deviations. In some examples, it is desirable that the glass substrate have a flatness metric that is low and, for example, below a flatness metric threshold (e.g., a flatness degradation threshold). In various examples, the flatness metric threshold may be 10 μm (microns), 20 μm, or 30 μm, etc. However, for HAMR applications, the temperatures during deposition may be 650° C. to 700° C. or higher to ensure proper crystal orientation for the magnetic layer structure. At such high temperatures, glass substrate materials may transform and deform and, as a result of the transformation, the flatness of the substrate may be significantly degraded, causing a corresponding degradation in properties of the resulting media disk, such as the aforementioned mechanical problems (e.g., head flyability and shock performance).

The temperature at which the glass substrate undergoes a substantial transformation with increasing temperature may be referred to as a transition temperature (Tg). In some aspects, the Tg may correspond to a substantial change in the expansion rate, which often occurs between a strain point temperature (viscosity=10^{14.5} poise) and an annealing point temperature (viscosity=10¹³ poise), where poise is a centimeter-gram-second unit of dynamic viscosity equal to one dyne-second per square centimeter. In some aspects, at the strain point temperature, the glass substrate may still be rigid, while at the higher annealing point temperature, the glass substrate may start to soften. Note that the glass material that is often used in state-of-the-art substrates for HAMR is so-called amorphous glass. In contrast with crystalized glass, amorphous glass exhibits a “super-cooled melt” condition and a “quasi-solid melt” condition. Herein, at least some aspects of the disclosure are applicable to either amorphous glass or crystalline glass.

In some scenarios, the Tg of a glass material may be used to determine whether that glass material is appropriate for a given application. For example, a glass material may be deemed adequate for use as a substrate for a disk if the Tg is above a deposition temperature by a certain margin. However, various glass properties such as viscosity, expansion rate, volume, and others can be used to determine the Tg of a glass material. Consequently, different Tg values may be provided for a given glass material depending on the manner in which Tg is calculated. This uncertainty presents a problem for scenarios such as selecting a glass substrate for HAMR where it is imperative to select a glass with the characteristic that the flatness of the glass after heating (e.g., after a deposition process) is predictable.

### Example Data Storage Device

Before discussing methods, apparatus, and materials that employ glass substrates as taught herein, an example of a disk drive is described in which media having such a glass substrate may be used.

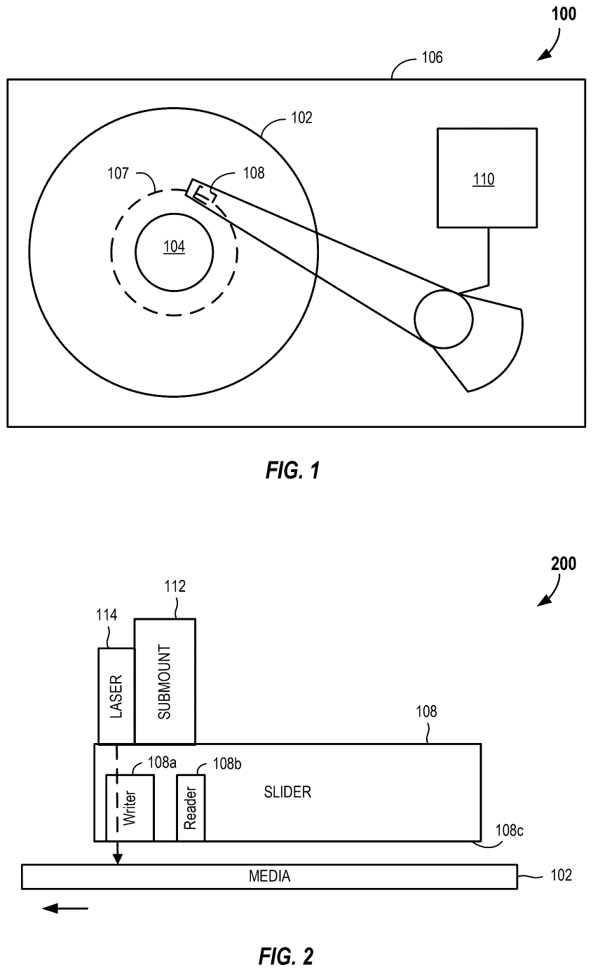

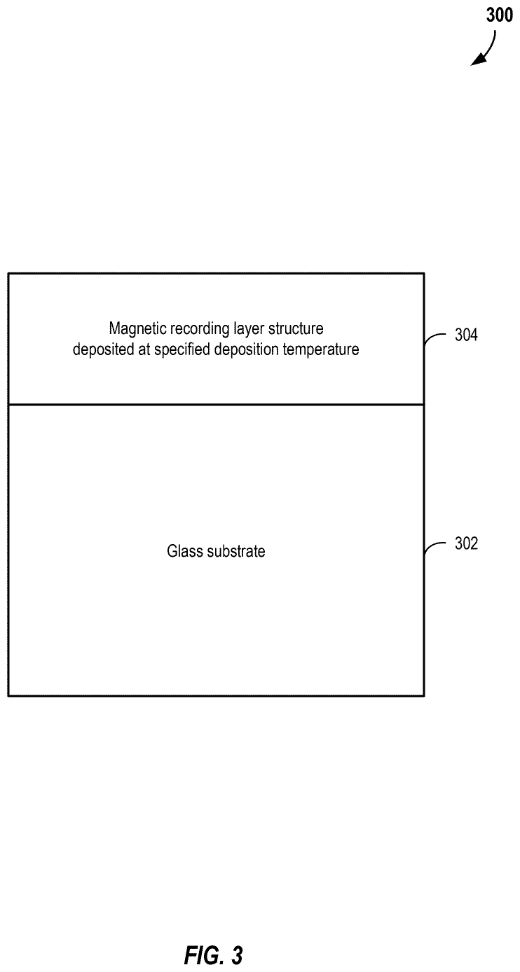

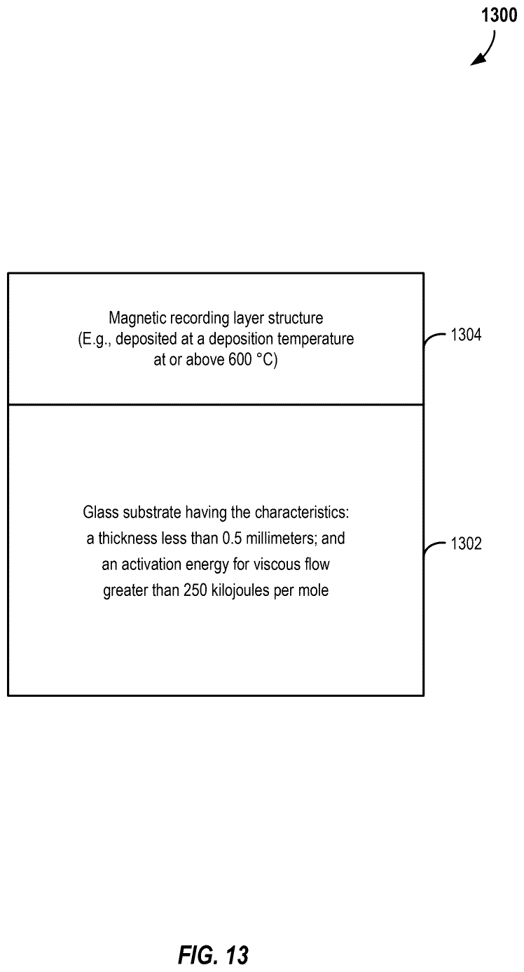

FIG. 1 is a top schematic view (plan view) of a data storage device 100 (e.g., disk drive or magnetic recording device) configured for HAMR including a head (slider) 108 and a magnetic recording medium (disk/media) 102 having a glass substrate (not visible in FIG. 1, but see FIGS. 3 and 13, discussed below) selected, configured or characterized according to one or more aspects of the disclosure described in detail below. Typically, a magnetic storage device such as the data storage device 100 will incorporate multiple magnetic recoding media (e.g., magnetic recording disks) 102 and heads (e.g., magnetic heads) 108. To reduce the complexity of FIGS. 1 and 2, only a single magnetic recoding media and a single head are shown in these figures. The laser (not visible in FIG. 1, but see laser 114 in FIG. 2) is positioned with the head/slider 108. The magnetic recording medium 102 may include one or more disks/media (referred to herein as disk/media 102 for convenience) for storing data. Disk/media 102 resides on a spindle assembly 104 that is mounted to a drive housing. Data may be stored along tracks in the magnetic recording layer of the disk/media 102. The reading and writing of data are accomplished with the head (slider) 108 that may have both read and write elements (see read element 108a and write element 108b of FIG. 2). The write element 108a is used to alter the properties of the magnetic recording layer of the disk/media 102 and thereby write information thereto. In one aspect, the head 108 may have magneto-resistive (MR), giant magneto-resistive (GMR), or tunnel magneto-resistive (TMR) elements. In an alternative aspect, the head 108 may be another type of head, for example, a Hall effect head. In operation, a spindle motor (not shown) rotates the spindle assembly 104, and thereby rotates the disk/media 102 to position the head 108 at a particular location along a desired disk track 107. The position of the head 108 relative to the disk/media 102 may be controlled by the control circuitry 110 (e.g., a controller such as a microcontroller, etc.). For example, the data storage device 100 may include a drive mechanism (not shown) for positioning a given magnetic head over a corresponding magnetic recording disk, whereby the control circuitry 110 is coupled to the magnetic head(s) for controlling operation of the magnetic head(s).

FIG. 2 is a side schematic view (profile view) 200 of the slider 108 and the magnetic recording medium 102 of FIG. 1. The magnetic recording medium 102 includes a glass substrate (not visible in FIG. 2, but see FIGS. 3 and 13, discussed below) configured or characterized according to one or more aspects of the disclosure. The slider 108 may include a submount 112 attached to a top surface of the slider 108. The laser 114 may be attached to the submount 112, and possibly to the slider 108. The slider 108 includes a write element (e.g., writer) 108a and a read element (e.g., reader) 108b positioned along an air bearing surface (ABS) 108c of the slider for writing information to, and reading information from, respectively, the disc/media 102.

In operation, the laser 114 is configured to generate and direct light energy to a waveguide (e.g., along the dashed line in FIG. 2) in the slider 108 which directs the light to a near field transducer (NFT) (not shown) near the air bearing surface (e.g., bottom surface) 108c of the slider 108. Upon receiving the light from the laser 114 via the waveguide, the NFT generates localized heat energy that heats a portion of the disk/media 102 within or near the write element 108a, and near the read element 108b. The anticipated writing (recording) temperature is in the range of about 350° C. to 500° C. in some examples. For example, the writing temperature may be around the Curie temperature (Tc) of a magnetic material such as an FePt alloy (e.g., having a Tc of approximately 455° C.). For a Tc of 455° C., the writing may be conducted in the range of 450° C. to 480° C. in some examples. In the aspect illustrated in FIG. 2, the laser directed light is disposed within the writer 108a and near a trailing edge of the slider 108. In other aspects, the laser directed light may instead be positioned between the write element 108a and the read element 108b.

FIGS. 1 and 2 illustrate a specific example of an HAMR-based system. In various examples, the magnetic recording medium 102 with the glass substrate according to aspects of the disclosure can be used in other suitable HAMR-based systems (e.g., with other sliders configured for HAMR) or for use with other magnetic recording technologies. Herein, many of the examples are HAMR examples, but at least some aspects of the present disclosure are not limited to HAMR, and other magnetic recording technologies may be employed, such as other types of energy assisted recording technology (e.g., a spin torque oscillator (STO) in a microwave assisted magnetic recording (MAMR) head) or non-energy assisted recording technology.

In some examples, the construction of a disk for HAMR may involve the use of relatively high deposition temperatures. For example, the sputter deposition temperature used when creating such a disk may be on the order of 600° C. in some cases.

FIG. 3 illustrates, in a simplified form, an example of a magnetic recording medium, platform or structure 300. The magnetic recording medium, platform or structure 300 includes at least a glass substrate 302 and a magnetic recording layer structure 304 deposited thereon via a sputter deposition process or some other process. In some examples, sputter deposition is a physical vapor deposition process that is used to create a thin film of a material by ejecting atoms or molecules from a target material onto a substrate.

The magnetic recording layer structure 304 may have various layers and sub-layers that are not shown here. Moreover, other layers may be provided, such as adhesion layers, heat sink layers, etc., which for clarity and simplicity are not shown in FIG. 3. The magnetic recording layer structure 304 is deposited onto the substrate (or onto intermediate layers between the substrate and the magnetic recording layer structure) at the aforementioned media deposition temperature.

### Flatness Degradation in HAMR Media

Some manufacturers select the particular glass substrate to be used for HAMR media based on a transition temperature (Tg) of the glass. In some aspects, Tg may refer to the approximate temperature at which glass transforms from a hard state a softer state. Thus, Tg may be used for estimating the structural integrity of a glass material at a certain temperature. Conventionally, Tg has been used for HAMR-based processes that employ temperatures of up to 600° C. and substrate thicknesses of up to 0.5 millimeters (mm).

However, Tg has not been a standardized parameter in the glass industry or HDD industry when used for this purpose. In other words, as discussed above, the Tg parameter might not be based on a strict definition and, as such, may lead to unreliable results if used to characterize a glass substate in some scenarios (e.g., applications using higher temperatures and thinner substrates).

For example, to increase the memory capacity of an HDD, more platters can be incorporated into the HDD. The use of more platters dictates the use of thinner substrates if the size of the HDD is not increased. HDD memory capacity can also be increased by using higher deposition temperatures for better magnetic performance. However, using a thinner substrate at higher deposition temperatures results in increased flatness degradation.

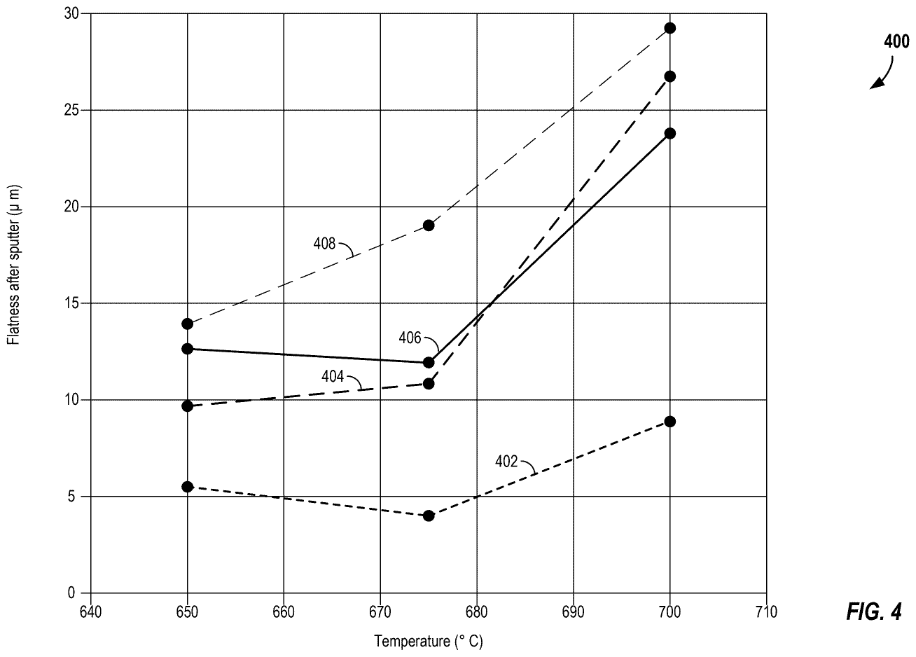

FIG. 4 depict a graph 400 (including plot points and associated plot lines) that illustrates changes in substrate flatness as function of the temperature used during a sputter deposition process (sputter temperature) with various substrate thickness. In some examples, flatness may be defined as the difference between a lowest point and a highest point on a disk (e.g., if the disk is lying on a horizontal plane). In some examples, a flatness degradation value may be an average flatness degradation of a plurality of flatness degradations for a plurality of disks. A first plot line 402 corresponds to a substate thickness of 0.5 mm, a second plot line 404 corresponds to a substate thickness of 0.43 mm, a third plot line 406 corresponds to a substate thickness of 0.40 mm, and a fourth plot line 408 corresponds to a substate thickness of 0.38 mm. As indicated by the plot lines of FIG. 4, substrates thinner than 0.5 mm show significant flatness changes with increased temperature.

The relationship between viscosity and temperature in glass can be described using an Arrhenius equation as shown in Equation 1. In some aspects, an Arrhenius equation may be used to estimate the temperature dependence of the rate at which a chemical reaction takes place. Thus, an Arrhenius equation may be used to estimate how the viscosity of a glass changes with changes in temperature.

$$η = {η}_{0} {e}^{\frac{{E}_{a}}{RT}} \qquad EQUATION 1$$

In Equation 1, η is the viscosity of the glass, η₀ is a pre-exponential factor that relates to the properties and structure of the glass, Ea is the activation energy for viscous flow for the glass, R is the universal gas constant, and T is the absolute temperature (in Kelvin). According to Equation 1, as the temperature (T) increases, the exponential term

$${e}^{\frac{{E}_{a}}{RT}}$$

decreases, leading to a decrease in viscosity. Thus, the glass flows more easily at higher temperatures.

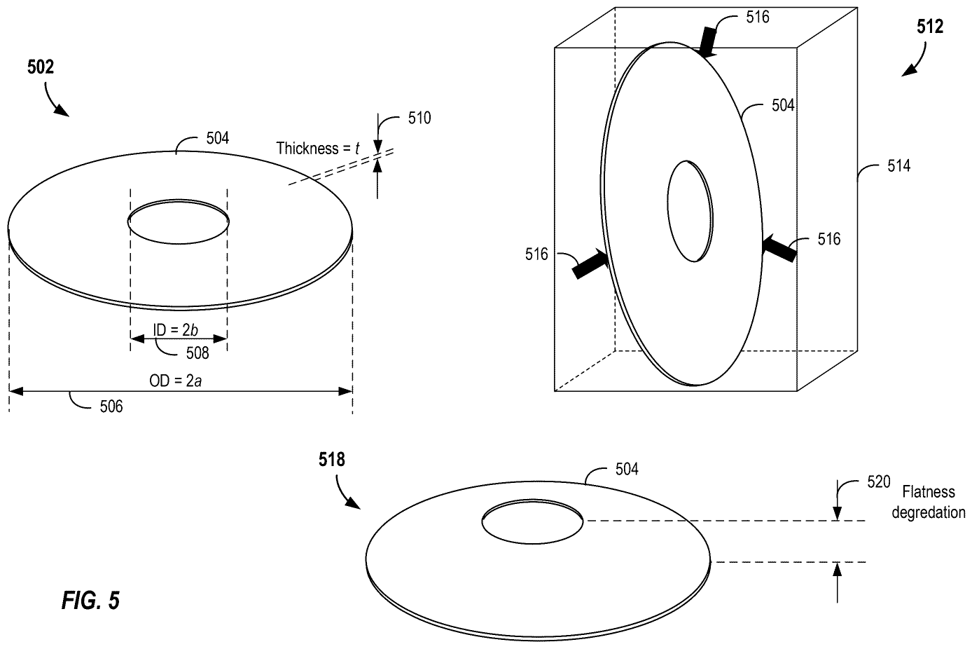

A disk may also be deformed due to pressure applied to the disk by disk support structures during a deposition process. FIG. 5 illustrates an example of how a deposition process may cause a disk to deform (buckle).

A first diagram 500 of FIG. 5 depicts a disk 504 that has an outer diameter (OD) 506, an inner diameter (ID) 508, and a thickness (t) 510. In this example, the OD 506 is characterized as equaling 2a, where a is the outer radius of the disk 504. In addition, the ID 508 is characterized as equaling 2b, where b is the inner radius of the hole of the disk 504.

A second diagram 512 depicts, in a simplified manner, how the disk 504 may be supported in a deposition chamber 514. As illustrated, several disk support structures 516 may contact the disk 504 a corresponding support points. As the disk 504 softens during the high temperature deposition process, the pressure applied on the disk 504 by the disk support structures 516 may cause the disk 504 to deform (buckle).

A third diagram 518 illustrates (e.g., in a somewhat exaggerated manner), that the disk 504 has buckled due to the deposition process. For example, instead of being completely flat, there is now some flatness degradation 520 across the surface of the disk 504.

Such flatness degradation may be characterized by the buckling equation set forth in Equation 2. This buckling equation may be applied to a scenario where a disk with an inner hole is supported at its outer circumference by three points (e.g., as shown in the second diagram 512 of FIG. 5).

$${P}_{cr} = \frac{{k}_{p} D}{{a}^{2}} \qquad EQUATION 2$$

In Equation 2, P_{cr} is the critical radial buckling load which corresponds to the force per unit length at each point of application (e.g., the force applied to the disk 504 by the disk support structures 516 in FIG. 5). The parameter kₚ is a dimensionless coefficient specific to the load pattern and geometry and the parameter a is the outer radius of the disk. The parameter D is the flexural rigidity of the disk (e.g., the disk 504), as given by Equation 3.

$$D = \frac{{Et}^{3}}{12 ( 1 - {v}^{2} )} \qquad EQUATION 3$$

In Equation 3, E is the Young's modulus (e.g., a ratio of tensile stress to tensile strain that indicates how easily the disk 504 can be stretched/deformed), v is the Poisson's ratio (e.g., the ratio of transverse contraction (or expansion) strain to longitudinal extension strain in the direction of a stretching force applied to the disk 504), and t is the thickness of the disk (e.g., the disk 504). Equation 2 may thus be rewritten as set forth in Equation 4.

$${P}_{cr} = \frac{{π}^{2} {α Et}^{3}}{6 ( 1 - {v}^{2} ) {a}^{2} ( 1 - \frac{{b}^{2}}{{a}^{2}} ) {( 1 + \frac{b}{a} )}^{2}} \qquad EQUATION 4$$

Here, b is the inner radius of the hole of the disk, and a is a constant.

To predict the flatness behavior of glass at higher temperatures, the Arrhenius and buckling equations set forth above may be combined to illustrate the relationship shown in Equation 5.

$$Flatness degradation ∝ \frac{Time}{{η}_{0}} \frac{E}{{t}^{3}} \frac{1}{{e}^{\frac{{E}_{a}}{RTs}}} \qquad EQUATION 5$$

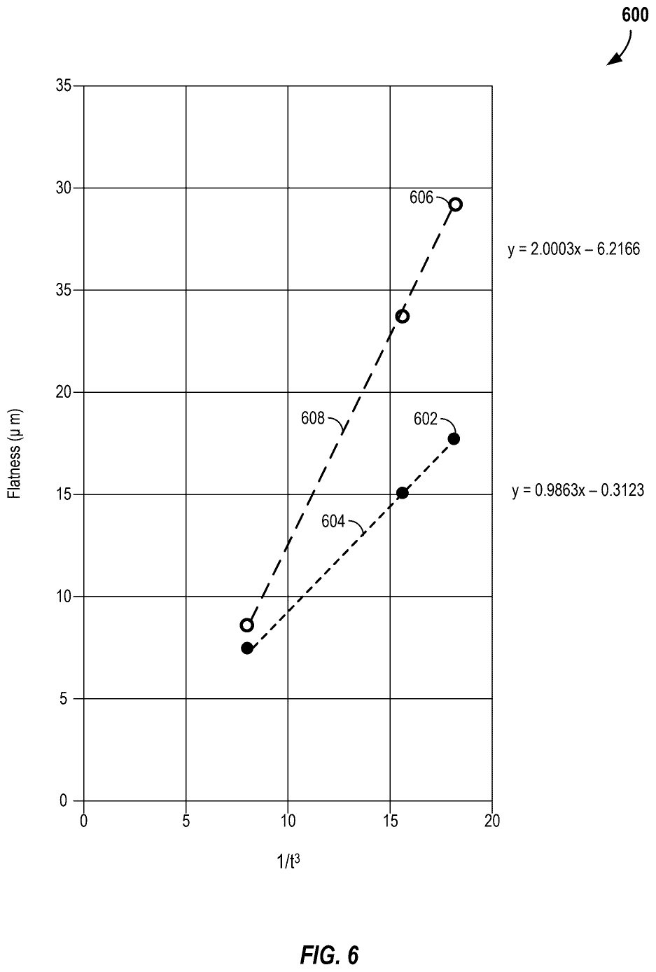

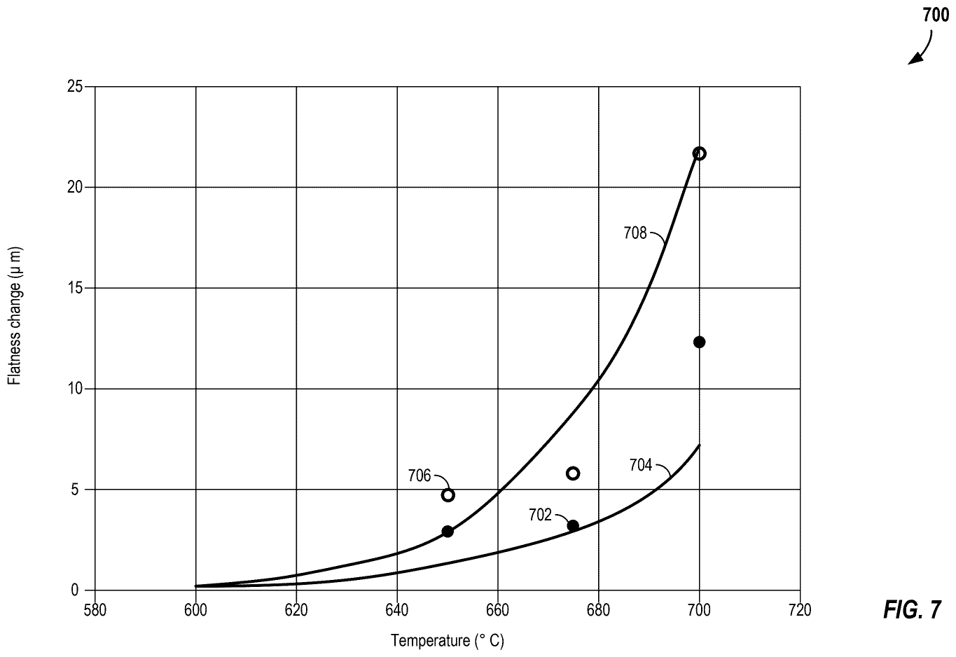

Here, Time is the sputter deposition time, and Ts is the sputter deposition temperature. From Equation 5, it may be observed that flatness degradation is a function of sputter time, thickness (t³), and viscoelastic characteristics of the glass (Ea and η₀). FIGS. 6 and 7 illustrate how flatness degradation measurements correlate to Equation 5.

FIG. 6 is a graph 600 that illustrates flatness as function of 1/t³. A first set of plots (represented by filled circles such as the circle 602) and an associated plot line 604 illustrate flatness as function of 1/t³ for a first type of glass. A second set of plots (represented by open circles such as the circle 606) and an associated plot line 608 illustrate flatness as function of 1/t³ for a second type of glass.

FIG. 7 is a graph 700 that illustrates flatness as function of sputter temperatures. A first set of plots (represented by filled circles such as the circle 702) and an associated plot line 704 illustrate flatness as function of sputter temperature for a first type of glass. A second set of plots (represented by open circles such as the circle 706) and an associated plot line 708 illustrate flatness as function of sputter temperature for a second type of glass.

FIGS. 6 and 7 illustrate that Equation 5 can provide reasonably accurate estimations for the flatness degradation of a glass substrate under real conditions. For example, as in Equation 5, the flatness degradation is worse with thinner substrates and at higher temperatures.

### Using Activation Energy to Determine Suitability of a Glass Substrate

As discussed above, the flatness degradation of a glass substrate is a function of the activation energy (Ea) of the glass substrate. Thus, the activation energy of a glass substrate may be used to determine whether the glass substrate is suitable for use in a magnetic recording medium. For example, if the activation energy of the glass substrate exceeds a certain threshold for a given glass thickness and sputter temperature, the deformation of the glass substrate will be within an acceptable range (e.g., 10 microns or less, 20 microns or less, 30 microns or less, etc.).

Thus, in some examples, the activation energy of a glass substrate may be used to determine whether the glass substrate is suitable for use in an HAMR-based process where the disk thickness is less than 0.5 mm. In such a process, the sputter temperature may exceed 650° C. or even 700° C.

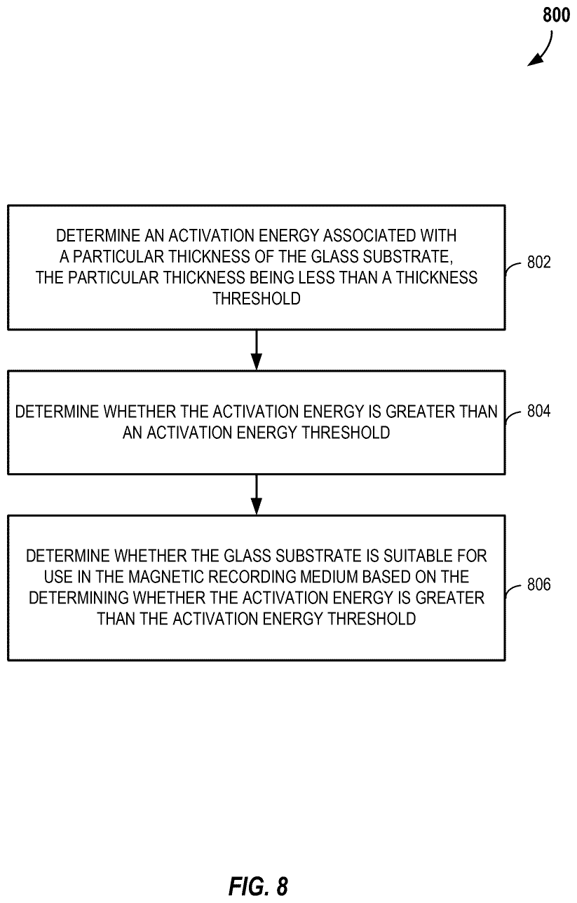

FIG. 8 illustrates a method 800 that may be performed to determine whether a glass substrate is suitable for use in a magnetic recording medium. In some examples, some or all of the operations of the method 800 may be performed by a computer processor, controller, or other suitable device or entity for characterizing a glass substrate. The computer processor may be, for example, a general purpose processor programmed with software or an application-specific integrated circuit (ASIC) or other suitable hardware-, software-, or firmware-based device. In some examples, the computer processor or other device controls a thermomechanical analyzer (or other suitable measurement device or apparatus) to measure the mechanical expansion of a candidate glass-based material versus temperature over a selected temperature range (e.g., 580° C. to 820° C.) that extends up to a deposition temperature for HAMR media. The thermomechanical analyzer may perform a measurement technique in which a deformation of a sample under non-oscillating stress is monitored against temperature while the temperature of the sample, in a specified atmosphere, is adjusted over a range of values.

At block 802 of FIG. 8, the computer processor or other suitable entity determines an activation energy associated with a particular thickness of a glass substrate. In some examples, this approach is used if the particular thickness is less than a thickness threshold (e.g., 0.5 mm). As discussed in more detail below, in some examples, such a determination may be based on a strain point and an annealing point of the glass substrate and/or based on Equation 1. For example, determining the activation energy may include: determining a strain point of a glass substrate, determining an annealing point of the glass substrate, and identifying the activation energy based on the strain point and the annealing point.

At block 804, the computer processor or other suitable entity determines whether the activation energy is greater than an activation energy threshold. In some examples, the activation energy threshold is 250 kilojoules per mole (KJ/mol) for a glass substrate with a thickness of 0.43 mm. Other activation energy thresholds may be used in other examples.

At block 806, the computer processor or other suitable entity determines whether the glass substrate is suitable for use in a magnetic recording medium. As discussed herein, this determination may be based on the determination of whether the activation energy is greater than the activation energy threshold (e.g., the result of block 804).

As mentioned above, different activation energy thresholds may be used in different examples. For example, different activation energy thresholds may be used for different thicknesses of the glass substate, for different types of glass substrates, for different sputter temperatures, for different sputter times, and so on. In some examples, an activation energy threshold may be selected by determining the activation energy that is needed to achieve a desired flatness characteristic.

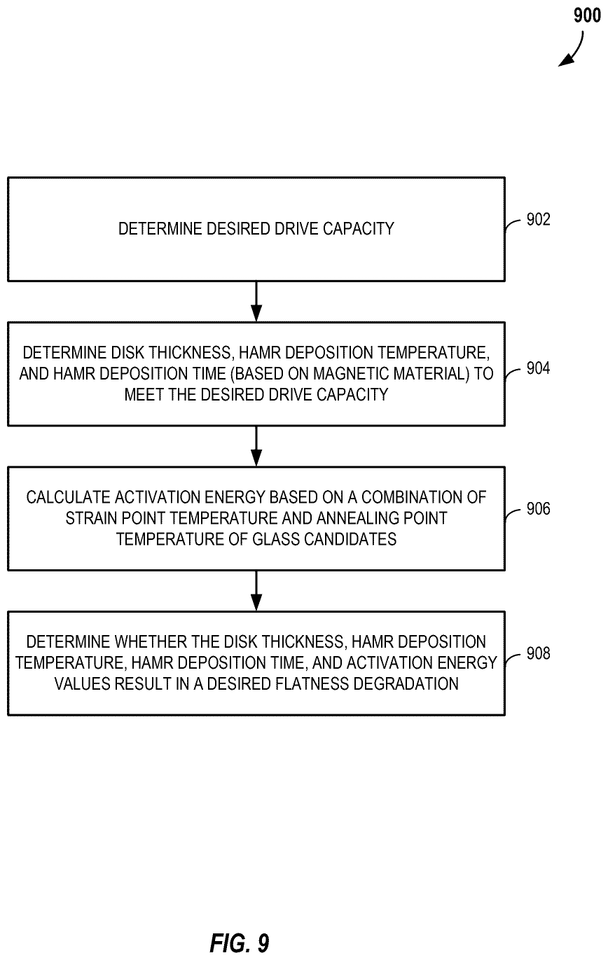

FIG. 9 illustrates a method 900 that may be performed to determine a suitable glass material to be used for a particular process (e.g., HAMR) taking into account the desired flatness degradation (e.g., pursuant to Equation 5). In some examples, some or all of the operations of the method 900 may be performed by a computer processor, controller, or other suitable device or entity.

At block 902 of FIG. 9, the computer processor or other entity determines the desired drive capacity. For example, a glass substrate may need to be selected for a HDD that will have certain dimensions and a certain storage capacity.

At block 904, the computer processor or other entity determines the disk thickness, the HAMR deposition temperature, and the HAMR deposition time that are needed to provide disks that meet the desired drive capacity. That is, the disk thickness and the sputter temperature/time are selected to ensure that a sufficient number of disks of a certain capacity will fit in the HDD to meet the desired drive capacity.

In some aspects, one or more of these values may depend on the particular magnetic material that will be used for the drive. For example, a higher HAMR temperature and/or a longer HAMR deposition time may be needed for some types of magnetic materials to provide the desired areal density as compared to other types of magnetic materials.

At block 906, the computer processor or other entity calculates the activation energy based on a combination of the strain point temperature and the annealing point temperature of the glass candidates under consideration for the glass substrate. As discussed herein, an activation energy value can be used to select a suitable glass material. In some examples, a viscoelastic characteristic value and an activation energy value are determined or calculated together from the strain point and annealing point values.

At block 908, the computer processor or other entity determines whether the disk thickness, the HAMR deposition temperature, the HAMR deposition time, and the activation energy values result in a desired flatness degradation. For example, these values may be entered into Equation 5 to determine whether the resulting flatness degradation is less than a flatness degradation threshold (e.g., as discussed herein).

### Example Techniques for Determining the Activation Energy of a Glass Substrate

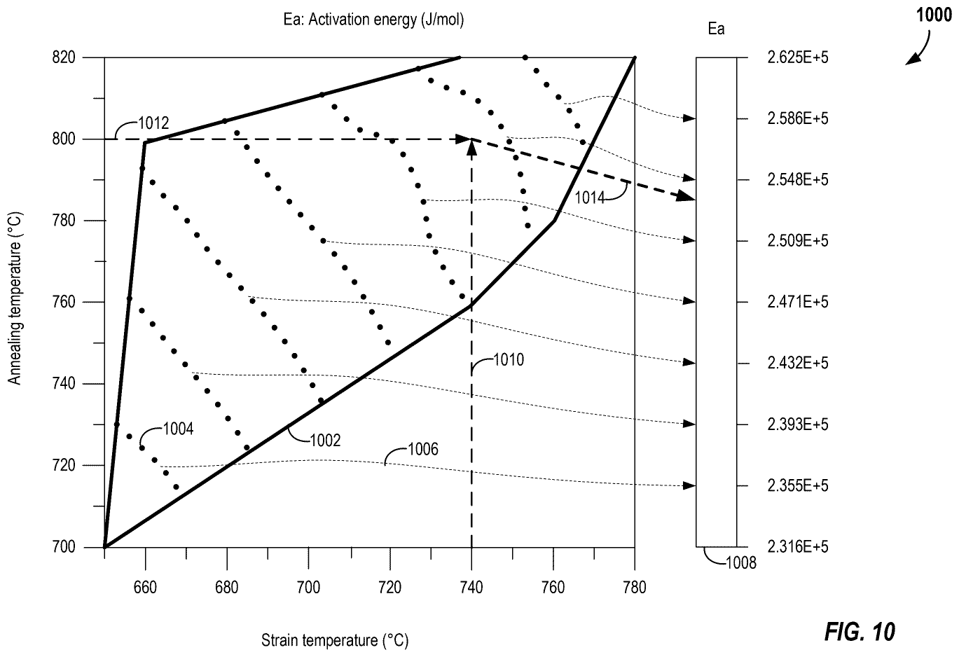

Turning now to FIGS. 10-13, several example techniques for determining the activation energy of a glass substrate will be described. Advantageously, these techniques do not rely on the Tg parameter which might not be based on a strict definition and, as such, may lead to unreliable results if used for an HAMR-based process. Instead, the techniques described below rely on viscosity as a function of temperature, which may provides for more rigorous characterization of a glass substrate.

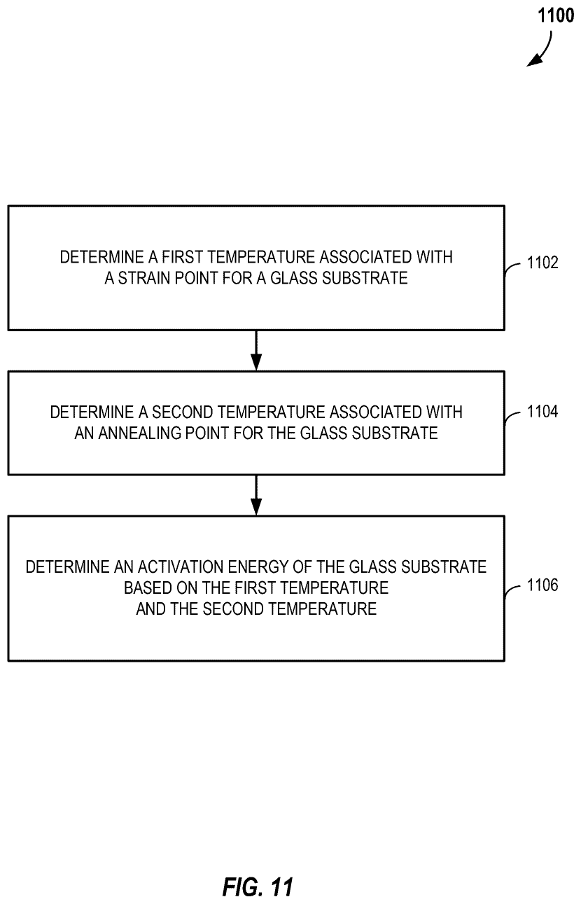

FIGS. 10 and 11 illustrate a technique for determining the activation energy of a glass substrate based on a strain point and an annealing point of the glass substrate. In some examples, a strain point refers to the temperature at which the internal stresses in a glass material are relieved after a few hours. In some examples, an annealing point refers to the temperature at which the internal stresses in a glass material are relieved after a few minutes. Thus, for a given material, the strain point may occur at a particular temperature and the annealing point may occur at different (higher) temperature. In some examples, the strain point and the annealing point of a material are defined by an industrial standard. In the Japanese Industrial Standard (JIS) R3103-02-2001, the strain point=10^{14.5} poises=10^{13.5} Pascal seconds (Pa·s), while the annealing point=10¹³ poises=10¹² Pa·s.

FIG. 10 illustrates a mapping 1000 of activation energy (Ea) to temperatures associated with strain points and temperatures associated with annealing points. The mapping 1000 includes a graph 1002 that is presented in a simplified form to facilitate black-and-white reproduction. In the graph 1002, combinations of the strain temperature and the annealing temperature map to various Ea values. In particular, traversing the graph 1002 from the lower left corner to the upper right corner corresponds to increasing values of Ea. Several dotted lines (e.g., a line 1004) are included in the graph 1002 to illustrate some of the combinations of the strain temperature and the annealing temperature that map to a given Ea value of a set of Ea values 1008. For example, any combination of the strain temperature and the annealing temperature that fall on the line 1004 may map (as represented by a dashed line 1006) to a particular Ea value (2.355×10⁵ in this example). Similar mappings are shown for the other dotted lines in the graph 1002.

The dashed lines of FIG. 10 illustrate a particular mapping of a strain temperature and an annealing temperature to an Ea value. Specifically, a strain temperature of 740° C. (corresponding to a dashed line 1010) and an annealing temperature of 800° C. (corresponding to a dashed line 1012) map to an Ea of approximately 2.573×10⁵ Joule per mole (257 KJ/mol).

In some examples, Equation 6 may be used to map the strain temperature and the annealing temperature to Ea. In some aspects, Equation 6 provides an empirical approach for estimating activation energy that may be less complex than a technique based on Equation 1 as discussed below.

$$Ea = K 1 Annealing + K 2 Strain + K3 \qquad EQUATION 6$$

In Equation 6, the parameters K1, K2, and K3 may be constant values. In some examples, the parameters K1, K2, and K3 may be determined empirically. In some examples, K1=111.1, K2=134.6, and K3=66666.

FIG. 11 illustrates a method 1100 that may be performed to determine the activation energy of a glass substrate. In some examples, some or all of the operations of the method 1100 may be performed by a computer processor, controller, or other suitable device or entity.

At block 1102 of FIG. 11, the computer processor or other suitable entity determines a first temperature associated with a strain point for a glass substrate.

At block 1104, the computer processor or other suitable entity determines a second temperature associated with an annealing point for the glass substrate.

At block 1106, the computer processor or other suitable entity determines the activation energy Ea of the glass substrate based on the first temperature and the second temperature (e.g., as discussed above).

As an alternative to the method 1100 based on Equation 6, the activation energy of a candidate glass material may be determined based on Equation 1. Equation 1 has two unknown values: η₀ and Ea. Upon determining the strain point temperature and the annealing point temperature of the candidate glass material, two sets of η and T values can be determined. From these sets of η and T values, the values of the unknowns, η₀ and Ea, can be calculated.

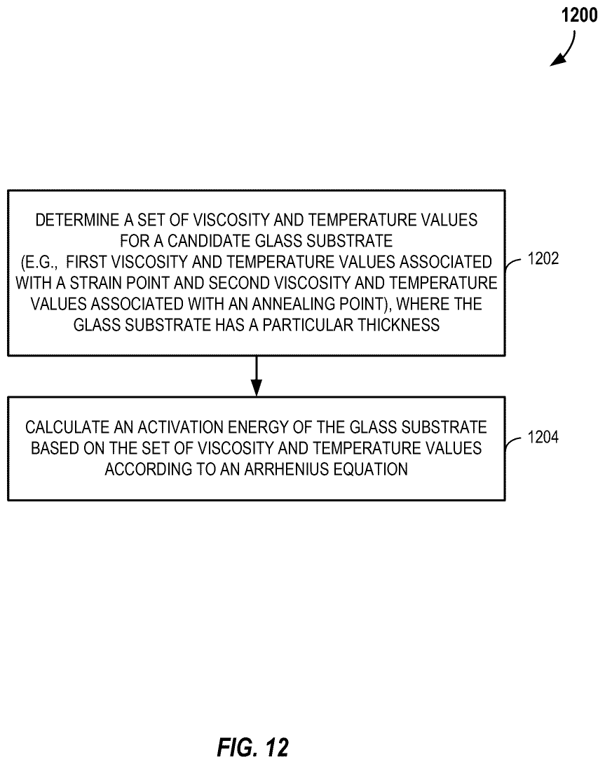

FIG. 12 illustrates a method 1200 that may be performed to determine the activation energy of a glass substrate based on a strain point and/or an annealing point of the glass substrate in conjunction with an Arrhenius equation (e.g., Equation 1). In some examples, some or all of the operations of the method 1200 may be performed by a computer processor, controller, or other suitable device or entity.

At block 1202 of FIG. 12, the computer processor or other suitable entity determines a set of viscosity and temperature values for a glass substrate, for a particular thickness of the glass substrate. This set of viscosity values may be, for example, a first viscosity value associated with a strain point of the glass substrate and a second viscosity value associated with an annealing point of the glass substrate. The set of temperature values may thus correspond to the strain point temperature and the annealing point temperature.

At block 1204, the computer processor or other suitable entity calculates the activation energy Ea of the glass substrate based on the set of viscosity and temperature values according to an Arrhenius equation (e.g., Equation 1). In some examples, this may involve generating a system of equations based on the strain point or the annealing point information determined at block 1202 incorporated into the equation to derive no and Ea.

In these examples, estimations of flatness deviation based on the above equations allows a manufacturer to select suitable glass material without making a real substrate and exposing the substrate to a real sputter process. Here, one example of flatness under known conditions may be used as a stating point. This calculation may also be used to define (e.g., characterize) the material itself.

Table 1 illustrates example Ea values for various glass thicknesses for a disk diameter of 97 mm. The different columns of Table 1 illustrates the Ea value for different flatness tolerances (relative to an example flatness tolerance associated with a 0.5 mm disk). The Ea values in Table 1 have a unit of kJ/mol as shown for the 250 Ea entry in the 1× column of Table 1.

TABLE 1

| Disk thickness | Flatness tolerance (x times the flatness for a 0.5 mm disk) | | | | |
|---|---|---|---|---|---|
| (mm) | 1x | 1.25x | 1.5x | 2x | 2.5x |
| 0.50 | 250 kJ/mol | 200 | 167 | 125 | 100 |
| 0.43 | 354 | 283 | 236 | 177 | 142 |
| 0.40 | 404 | 323 | 269 | 202 | 162 |
| 0.38 | 439 | 351 | 293 | 220 | 176 |
| 0.30 | 602 | 482 | 401 | 301 | 241 |
| 0.28 | 650 | 520 | 433 | 325 | 260 |

In some examples, if the flatness of a disk needs to be same as the flatness of a conventional 0.5 mm disk, an Ea of greater than 250 will be needed in a typical example as shown in the 1× column of Table 2. If a larger flatness degradation is allowed (e.g., twice the flatness degradation of a 0.5 mm disk as shown in the 2× column of Table 2), a thinner substrate can meet the flatness requirement with the same Ea. As a first example, if a 0.5 mm disk (Ea=250) has an average flatness deviation of 5 μm and an HDD allows up to 7.5 μm of flatness deviation, a 0.43 mm disk can meet this requirement. Conversely, as a second example, if 10 μm of flatness deviation (2 times the first example) is acceptable, a 0.38 mm disk can meet the requirement.

Example Magnetic Recording Structure with Glass Substrate

Turning now to FIG. 13, an example of a magnetic recording structure with a glass substrate will be described for use with HAMR or other magnetic recording technologies.

FIG. 13 illustrates, in simplified form, an exemplary magnetic recording medium (e.g., platform or structure) 1300 having a glass substrate 1302 and a magnetic recording layer structure 1304 (which may be referred to simply as a magnetic recording layer 1304 in some examples) deposited thereon. In some examples, the magnetic recording medium 1300 may take the form of a magnetic recording disk that includes the magnetic recording layer 1304 on the glass substrate 1302, where the magnetic recording layer 1304 is configured to store information (e.g., as discussed herein). The glass substrate 1302 includes a glass material having the characteristics: a thickness of the glass substrate is less than 0.5 millimeters, and an activation energy for viscous flow of the glass substrate is greater than 250 kilojoules per mole. In some examples, the diameter of the glass substrate 1302 is greater than 95 millimeters (e.g., 97 millimeters, etc.).

In some examples, the glass substrate is a low alkaline glass. For example, the glass substrate may have an alkali content that is less than 0.5 percent of the glass substrate by weight.

The magnetic recording layer structure 1304 may have various layers and sub-layers that are not shown here. Moreover, other layers may be provided, such a base or bottom layer, adhesion layers, heat sink layers, underlayers, a capping or coupling layer, a lubricant layer or carbon overcoat on the capping or coupling layer, etc., which for clarity and simplicity are not shown in the figure. The magnetic recording layer structure 1304 is deposited onto the substrate (or onto intermediate layers between the substrate and the magnetic recording layer structure) at a deposition temperature applicable the intended use case. In some examples (e.g., for HAMR applications), the magnetic recording layer structure 1304 may be deposited on the glass substrate using a deposition temperature of greater than 600° C.

By using a glass material having the aforementioned characteristics, degradations in flatness of the glass substrate 1302 during high temperature deposition of the magnetic recording layer structure 1304 may be avoided so as to avoid corresponding degradation in the magnetic recording medium 1300, such as degradation in the aforementioned mechanical properties. The characteristics shown in FIG. 13 are not the only characteristics that may be achieved within the glass substrate 1302. By way of example, combinations of materials, thickness, disk size, and internal stress (function of deposition temperature) may be employed.

In some examples, the magnetic recording layer structure 1304 is made of L10 ordered FePt, L10 ordered CoPt, and/or L10 ordered FePd. In some examples, a coupling layer is made of one or more materials such as Ta, Pt, Ru, Ag, Au, Cu, Al, NiTa, C, SiC, SiN, TiC, TiN, and/or other suitable materials. In some examples, a coupling layer is deposited using sputter deposition. In some examples, the magnetic recording layer structure 1304 includes FePtXY, CoPtXY and/or FePdXY, where X is selected from the group including Ag, Cu, Ni, BN, B, SiO2, SiN, SiC, and/or C, and where Y is selected from the group including ZrO2, TiO2, MgO, ZrO2, Cr2O3, Ta2O5, NbO5, HfO2, WO3, Y2O3, B2O3, and/or Al2O3.

In some examples, all layers of the magnetic recording medium 1300 are formed using sputtering. However, in other examples, the deposition of such layers can be performed using a variety of deposition sub-processes, including, but not limited to physical vapor deposition (PVD), sputter deposition and ion beam deposition, and chemical vapor deposition (CVD) including plasma enhanced chemical vapor deposition (PECVD), low pressure chemical vapor deposition (LPCVD) and atomic layer chemical vapor deposition (ALCVD). In other examples, other suitable deposition techniques known in the art may also be used. In several embodiments, the materials for an adhesion layer, a heat sink layer, and underlayers can be those materials that are well known in the art for these layers. In some examples, the heat sink layer can be made of one or more materials such as Ag, Al, Au, Cu, Cr, Mo, Ru, W, CuZr, MoCu, AgPd, CrRu, CrV, CrW, CrMo, CrNd, NiAl, NiTa, and/or other suitable materials known in the art. In some examples, the underlayers include a growth layer directly below a recording layer, where the growth layer can be made of one or more materials such as Cr, Mo, NiAl, MgO, TiC, TiN, Ag, CrMo, Pt, Pd, Ru, and/or other suitable materials known in the art.

### Example System or Apparatus

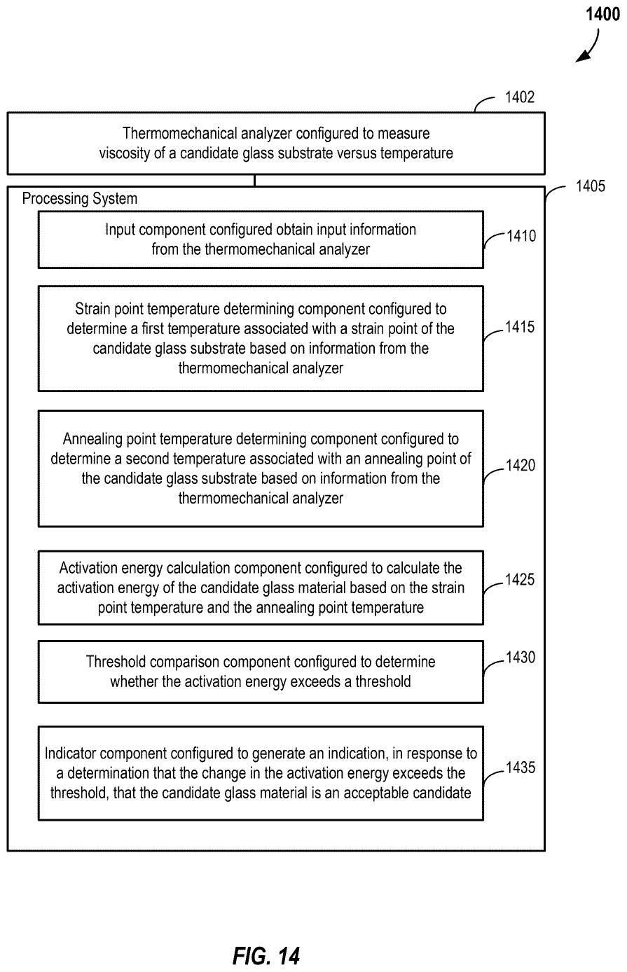

FIG. 14 illustrates a system or apparatus 1400 that may be used to implement any of the methods described herein (e.g., the method 800 of FIG. 8). The apparatus 1400 includes a thermomechanical analyzer 1402 configured to measure mechanical expansion of a candidate glass material versus temperature. For example, the thermomechanical analyzer 1402 may measure the elongation and/or other volume change of a glass substrate as the glass substrate is heated to determine the strain point temperature and/or the annealing point temperature of the glass substrate.

The apparatus 1400 also includes a processor or processing system 1405 (e.g., a computer processor) configured to control the thermomechanical analyzer 1402 and to analyze data obtained therefrom. The processing system 1405 includes an input component 1410 configured to obtain input information from the thermomechanical analyzer and/or other sources. The processing system 1405 includes a strain point temperature determining component 1415 configured to determine a first temperature associated with a strain point of the candidate glass substrate based on information from the thermomechanical analyzer. The processing system 1405 includes an annealing point temperature determining component 1420 configured to determine a second temperature associated with an annealing point of the candidate glass substrate based on information from the thermomechanical analyzer. The processing system 1405 includes an activation energy calculation component 1425 configured to calculate the activation energy of the candidate glass material based on the strain point temperature and the annealing point temperature. The processing system 1405 includes a threshold comparison component 1430 configured to determine whether the activation energy exceeds a threshold. The processing system 1405 includes an indicator component 1435 configured to generate an indication, in response to a determination that the change in the activation energy exceeds the threshold, that the candidate glass material is an acceptable candidate. Note that in some examples, a single processor is configured to include each of the processing components shown in FIG. 14 (e.g., components 1410, 1415, 1420, 1425, 1430, and 1435).

### Additional Aspects

The examples set forth herein are provided to illustrate certain concepts of the disclosure. The substrates, apparatuses, devices, or components illustrated above may be configured to provide one or more of the features, methods, or steps described herein. Those of ordinary skill in the art will comprehend that these are merely illustrative in nature, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, a substrate may be manufactured, an apparatus may be implemented, or a method may be practiced using any number of the aspects set forth herein. In addition, such a substrate, apparatus, or method may be implemented or practiced using other structure, functionality, or structure and functionality in addition to or other than one or more of the aspects set forth herein.

Various components described in this specification may be described as “including” or made of certain materials or compositions of materials. In one aspect, this can mean that the component consists of the particular material(s). In another aspect, this can mean that the component comprises the particular material(s).

Some aspects of the present disclosure have been described above with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

Some of the subject matter described herein may be implemented in hardware, software, firmware, or any combination thereof. As such, the terms “function,” “module,” and the like as used herein may refer to hardware, which may also include software and/or firmware components, for implementing the feature being described. In one example implementation, the subject matter described herein may be implemented using a computer readable medium having stored thereon computer executable instructions that when executed by a computer (e.g., a processor) control the computer to perform the functionality described herein. Examples of computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

The various features and processes described above may be used independently of one another, or may be combined in various ways. All possible combinations and sub-combinations are intended to fall within the scope of this disclosure. In addition, certain method, event, state or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other suitable manner. Tasks or events may be added to or removed from the disclosed example embodiments. The example systems and components described herein may be configured differently than described. For example, elements may be added to, removed from, or rearranged compared to the disclosed example embodiments.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. It is further noted that the term “over” as used in the present application in the context of one component located over another component, may be used to mean a component that is on another component and/or in another component (e.g., on a surface of a component or embedded in a component). Thus, for example, a first component that is over the second component may mean that (1) the first component is over the second component, but not directly touching the second component, (2) the first component is on (e.g., on a surface of) the second component, and/or (3) the first component is in (e.g., embedded in) the second component. The term “about ‘value X’”, or “approximately value X”, as used in the disclosure shall mean within 10 percent of the ‘value X’. For example, a value of about 1 or approximately 1, would mean a value in a range of 0.9-1.1. In the disclosure various ranges in values may be specified, described and/or claimed. It is noted that any time a range is specified, described and/or claimed in the specification and/or claim, it is meant to include the endpoints (at least in one embodiment). In another embodiment, the range may not include the endpoints of the range.

1. A glass substrate for a magnetic recording medium,
a thickness of the glass substrate being less than 0.5 millimeters; and
an activation energy for viscous flow of the glass substrate being greater than 250 kilojoules per mole.

2. The glass substrate of claim 1, wherein a diameter of the glass substrate is greater than 95 millimeters.

3. The glass substrate of claim 1, wherein the activation energy is associated with a strain point of the glass substrate and an annealing point of the glass substrate.

4. The glass substrate of claim 3, wherein the activation energy is associated with a first temperature corresponding to the strain point and a second temperature corresponding to the annealing point.

5. The glass substrate of claim 1, wherein the glass substrate has an alkali content that is less than 0.5 percent of the glass substrate by weight.

6. The glass substrate of claim 1, wherein the activation energy for viscous flow corresponds to a flatness degradation that is less than a flatness degradation threshold.

7. The glass substrate of claim 6, wherein the flatness degradation is an average flatness degradation of a plurality of flatness degradations for a plurality of disks comprising the glass substrate.

8. The glass substrate of claim 6, wherein the flatness degradation threshold is 10 microns.

9. A magnetic recording disk, comprising:
the glass substrate of claim 1; and
a magnetic recording layer on the glass substrate and configured to store information.

10. The magnetic recording disk of claim 9, wherein the activation energy is associated with a strain point of the glass substrate and an annealing point of the glass substrate.

11. The magnetic recording disk of claim 10, wherein the activation energy is associated with a first temperature corresponding to the strain point and a second temperature corresponding to the annealing point.

12. The magnetic recording disk of claim 9, wherein the activation energy for viscous flow corresponds to a flatness degradation that is less than a flatness degradation threshold.

13. A magnetic storage device comprising:
a plurality of the magnetic recording disk of claim 9;
at least one magnetic head;
a drive mechanism for positioning the at least one magnetic head over one or more of the plurality of magnetic recording disks; and
a controller electrically coupled to the at least one magnetic head for controlling operation of the at least one magnetic head.

14. The magnetic storage device of claim 13, further comprising a slider comprising:
the at least one magnetic head;
a laser configured to generate light; and
a near field transducer (NFT) configured to receive the light and generate a localized heat;
wherein each of the plurality of magnetic recording disks further comprises a heat sink layer configured to dissipate the localized heat during a writing process.

15. A method for determining a suitability of a glass substrate for use in a magnetic recording medium, the method comprising:
determining an activation energy associated with a particular thickness of the glass substrate, the particular thickness being less than a thickness threshold;
determining whether the activation energy is greater than an activation energy threshold; and
determining whether the glass substrate is suitable for use in the magnetic recording medium based on the determining whether the activation energy is greater than the activation energy threshold.

16. The method of claim 15, wherein:
the thickness threshold is 0.5 millimeters; and
the activation energy threshold is 250 kilojoules per mole.

17. The method of claim 15, wherein the determining the activation energy comprises:
calculating the activation energy based on a viscosity of the glass substrate.

18. The method of claim 15, wherein the determining the activation energy comprises:
calculating the activation energy based on an Arrhenius equation.

19. The method of claim 15, wherein the determining the activation energy comprises:
determining a strain point of the glass substrate;
determining an annealing point of the glass substrate; and
identifying the activation energy based on the strain point and the annealing point.

20. The method of claim 15, wherein the determining the activation energy comprises:
determining a first temperature associated with a strain point of the glass substrate;
determining a second temperature associated with an annealing point of the glass substrate; and
identifying the activation energy based on the first temperature and the second temperature.

21. The method of claim 15, further comprising:
determining the activation energy threshold based on a flatness degradation threshold.

22. The method of claim 21, wherein the flatness degradation threshold is based on:
a sputter temperature of a deposition process;
a duration of the deposition process; and
the particular thickness of the glass substrate.
